(19) United States
(12) Patent Application Publication
(10) Pub. No.: US 2020/0239134 A1
(43) Pub. Date: Jul. 30, 2020

(54) HYBRID-ELECTRIC DUCTED FAN TRANSPORT

(71) Applicant: Bell Helicopter Textron Inc., Fort Worth, TX (US)

(72) Inventors: Daniel Bryan Robertson, Southlake, TX (US); Matthew Edward Louis, Fort Worth, TX (US); Kirk Landon Groninga, Keller, TX (US)

(73) Assignee: Bell Helicopter Textron Inc., Fort Worth, TX (US)

(21) Appl. No.: 16/257,696

(22) Filed: Jan. 25, 2019

(51) Int. Cl. B64C 29/00; B64C 11/00; B64D 29/04; B64C 11/46

(52) U.S. Cl. CPC B64C 29/0033; B64C 29/0025; B64C 11/46; B64D 29/04; B64C 11/001

(57) ABSTRACT

A rotorcraft featuring a fuselage, a forward fuselage ducted fan located in the fuselage, and an aft fuselage ducted fan located in the fuselage. The rotorcraft is directly powered by electricity and can be supplemented with additional powers sources. Two sets of pivoting ducted fans provide additional lift and thrust as needed to control the rotorcraft.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Conventional rotorcraft utilizing ducted fans for lift typically feature ducted fans driven directly by combustion engines. Combustion engines have been preferred because they can produce a large amount of power relative to the fuel required to operate them. However, using ducted fans driven directly by combustion engines can be inefficient and noisy during certain periods of flight. For example, rotorcraft having both ducted fans and a wing for lift will not likely need the ducted fans entirely during forward flight.

### BRIEF DESCRIPTION OF THE DRAWINGS

FIG. 1 is an oblique view of a rotorcraft according to this disclosure with opened louvers in vertical flight mode.

FIG. 2 is an oblique view of the rotorcraft of FIG. 1 with closed louvers in wing-borne flight mode.

FIG. 3 is a front view of the rotorcraft of FIG. 1 with open louvers in vertical flight mode.

FIG. 4 is a front view of the rotorcraft of FIG. 1 with closed louvers in wing-borne mode.

FIG. 5 is a side view of the rotorcraft of FIG. 1 with opened louvers in vertical flight mode.

FIG. 6 is a side view of the rotorcraft of FIG. 1 with closed louvers in wing-borne mode.

FIG. 7 is a top view of the rotorcraft of FIG. 1 with opened louvers in vertical flight mode.

FIG. 8 is a top view of the rotorcraft of FIG. 1 with closed louvers in wing-borne mode.

FIG. 9 is a front view of the rotorcraft of FIG. 1 with a deployed airstair.

FIG. 10 is a side view of the rotorcraft of FIG. 1 with a deployed airstair.

FIG. 11 is a schematic view of the control systems of the rotorcraft of FIG. 1.

FIG. 12 is a top view of a ducted fan with a closed pair of louvers according to this disclosure.

FIG. 13 is a top view of the ducted fan of FIG. 12 with an open pair of louvers.

### DETAILED DESCRIPTION

In this disclosure, reference may be made to the spatial relationships between various components and to the spatial orientation of various aspects of components as the devices are depicted in the attached drawings. However, as will be recognized by those skilled in the art after a complete reading of this disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

This disclosure describes a hybrid-electric rotorcraft having a pair of ducted fans located in a fuselage of the rotorcraft primarily for providing lift along with two pairs of pivotable ducted fans for selectively providing lift and thrust. Each of the ducted fans located outside the fuselage feature an orthogonal set of control surfaces to provide selective thrust control of the rotorcraft. During wing-borne flight, the pair of ducted fans in the fuselage are enclosed to make the rotorcraft more aerodynamic.

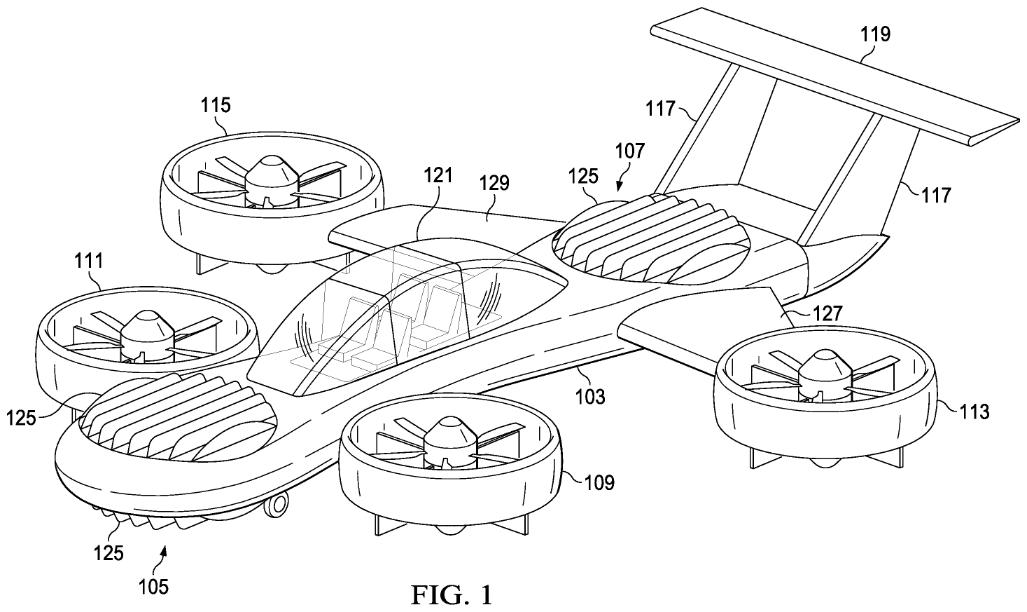

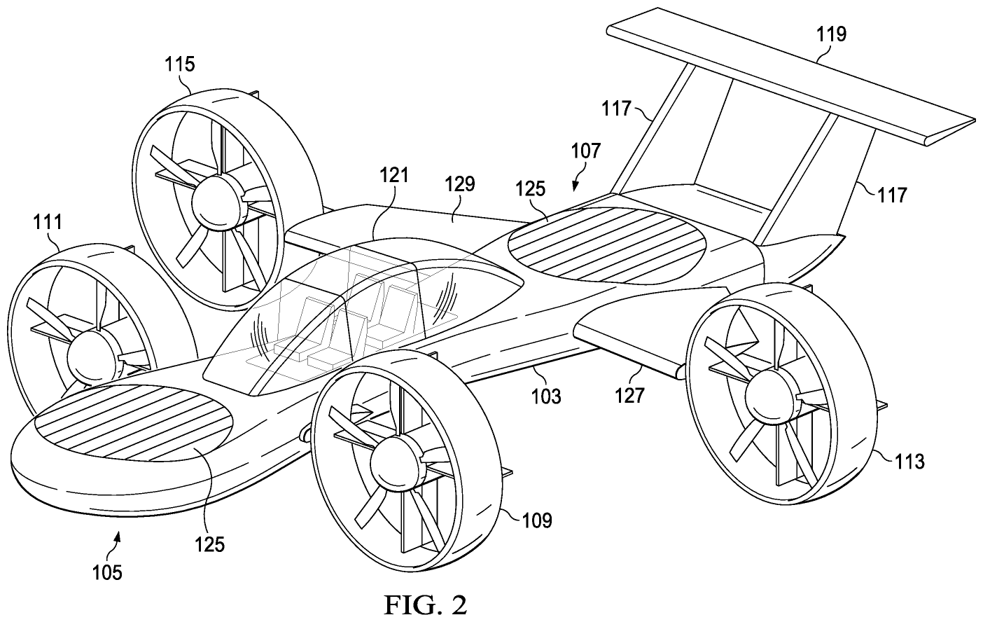

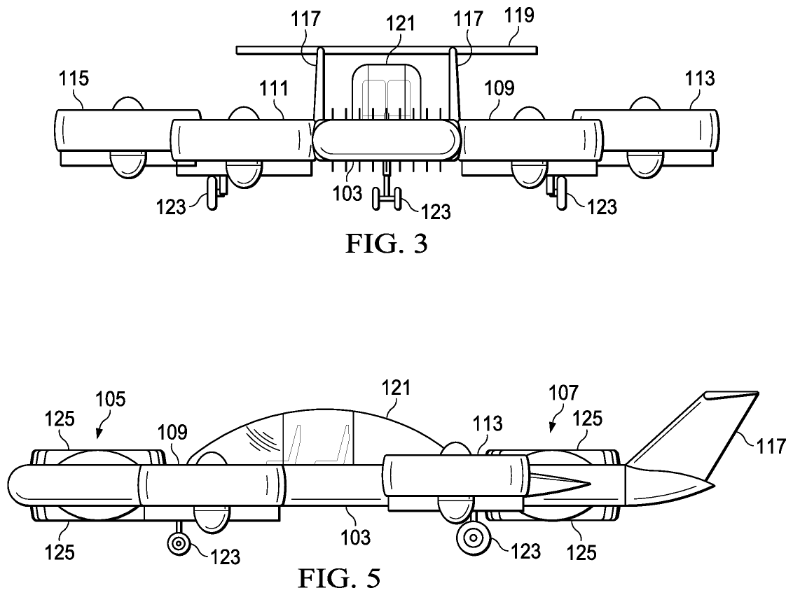

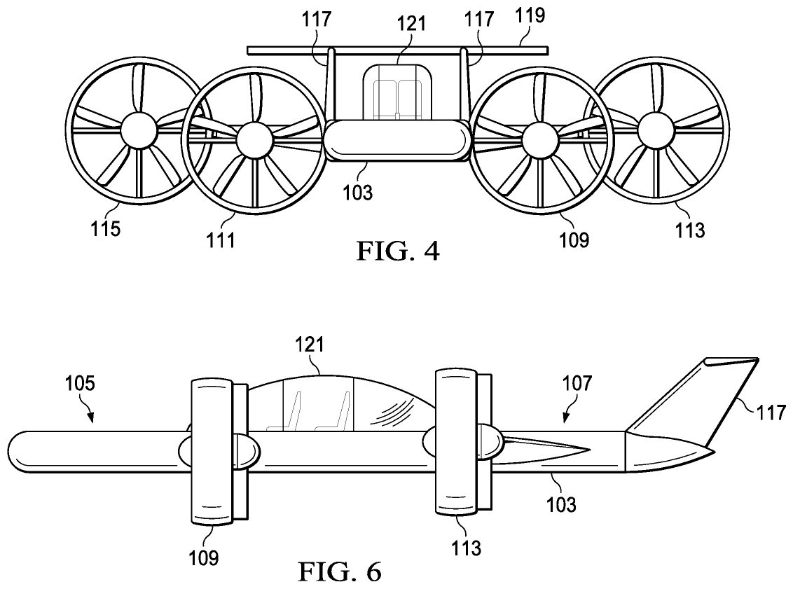

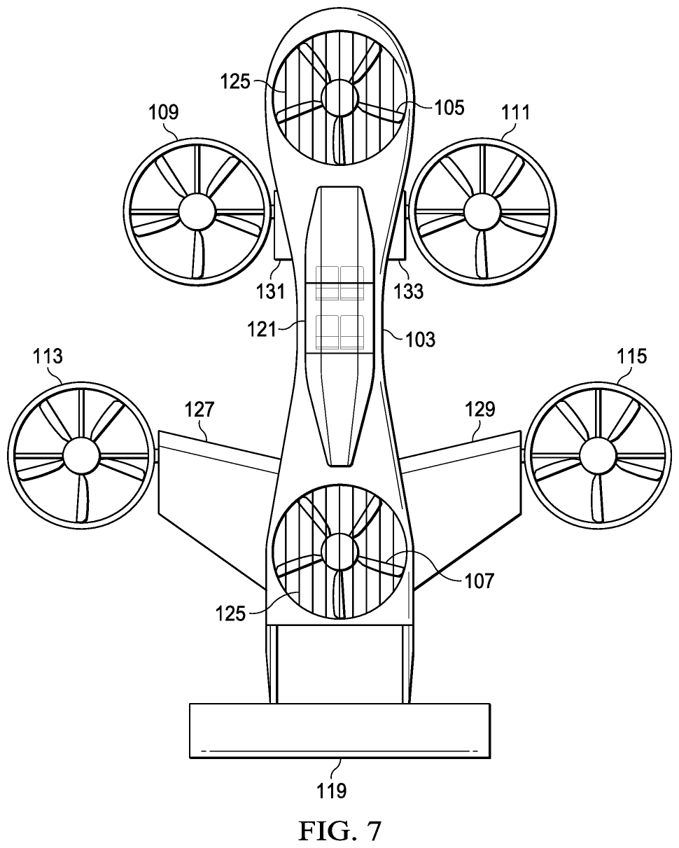

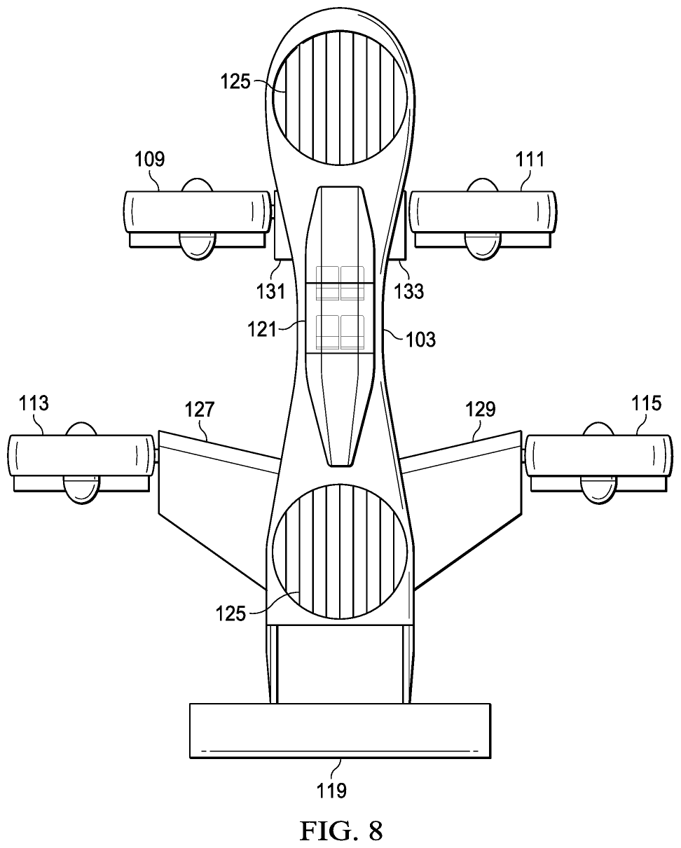

FIGS. 1-8 illustrate a rotorcraft 101 equipped with a plurality of ducted fans according to this disclosure. Rotorcraft 101 comprises a fuselage 103, a forward fuselage ducted fan 105, an aft fuselage ducted fan 107, a forward outboard left ducted fan 109, a forward outboard right ducted fan 111, an aft outboard left ducted fan 113, an aft outboard right ducted fan 115, a pair of vertical stabilizers 117, a horizontal stabilizer 119, a cabin 121, landing gear 123, louvers 125, an aft left wing 127, an aft right wing 129, a forward left aerodynamic fairing 131, and a forward right aerodynamic fairing 133. All the ducted fans are configured to provide vertical thrust as needed to lift the rotorcraft 101 and feature fan blades driven by electric motors. The fuselage ducted fans 105, 107 have the louvers 125 on both upper and lower sides of the fan, and the fans 105, 107 are only operated during takeoff and landing. Louvers 125 are open during takeoffs and landings; otherwise, the louvers 125 are closed. Closing the louvers 125 creates a more aerodynamic fuselage 103 during wing-borne flight.

The outboard ducted fans 109, 111, 113, 115 are located outboard of the fuselage 103. The forward outboard left ducted fan 109 is rotationally carried by the forward left aerodynamic fairing 131 and can pivot from horizontal to a vertical orientation through approximately 90 degrees of rotation. The forward outboard right ducted fan 111 is rotationally carried by the forward right aerodynamic fairing 133 and can pivot from horizontal to a vertical orientation through approximately 90 degrees of rotation. The aft outboard left ducted fan 113 is rotationally carried by the aft left wing 127 and can pivot from horizontal to a vertical orientation through approximately 90 degrees of rotation. The aft outboard right ducted fan 115 is rotationally carried by the aft right wing 129 and can pivot from horizontal to a vertical orientation through approximately 90 degrees of rotation. Each of the fans 109, 111, 113, 115 can be controlled independently to provide the operator with pitch, yaw, roll, and translation control as needed.

The cabin 121 is located mid-fuselage between the forward fuselage ducted fan 105 and the aft fuselage ducted fan 107. As illustrated, the cabin 121 is configured for seating four passengers, however other configurations are contemplated. The pair of vertical stabilizers 117 extend upwards from a rear of the fuselage 103 and support the horizontal stabilizer 119. Control surfaces (not shown) can be selectively located on the pair of vertical stabilizers 117 and the horizontal stabilizer 119 as needed. Landing gear 123 is typically wheel based and extends/retracts from the fuselage 103 and the aft wings 127, 129 as needed for landing.

The fuselage 103, as illustrated, has a teardrop shape having a width narrowest adjacent the cabin 121. Alternatively, the fuselage 103 features a width more uniform along a length of the aircraft. The forward left aerodynamic fairing 131 and the forward right aerodynamic fairing 133 utilizes an airfoil shape to provide lift during forward flight and are shorter in length than the aft left wing 127 and the aft right wing 129. The forward left aerodynamic fairing 131 and the forward right aerodynamic fairing 133 are the forward aerodynamic fairings and are located forward of the cabin 121. The wings 127, 129 each utilize an airfoil shape to provide lift during forward flight and are longer in length than the forward left aerodynamic fairing 131 and the forward right aerodynamic fairing 133. The aft left wing 127 and the aft right wing 129 are configured to provide most of the rotorcraft's lift during wing-borne flight and are forward swept. The wings 127, 129 are the aft wings and are located aft of the cabin 121. Alternative wing configurations are contemplated by this application, for example, a single wing instead of a pair of aft wings.

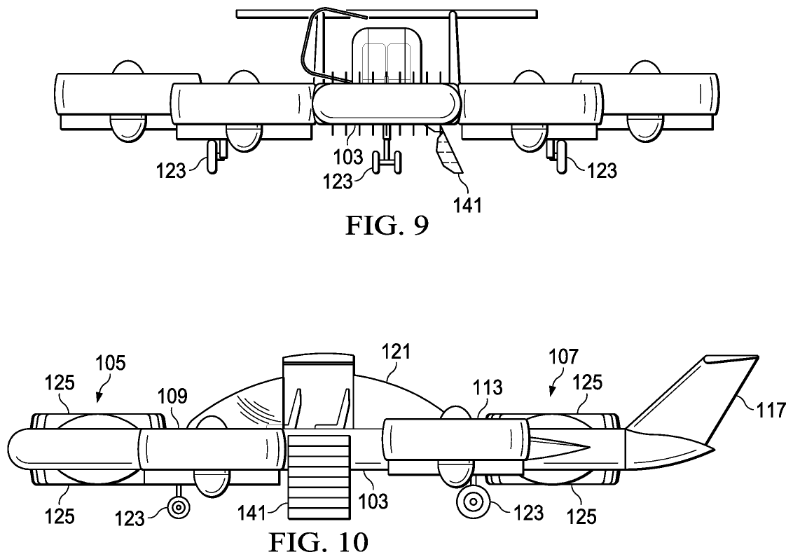

FIGS. 9 & 10 illustrate the rotorcraft 101 equipped with an airstair 141 according to this disclosure. Airstair 141 folds in and out of the fuselage 103 as needed for access to the cabin 121. Airstair 141 while may be located on either side of fuselage 103 as needed. Typically, the airstair 141 comprises a set of hinged steps pivotally carried by the fuselage 103. The cabin 121, as illustrated, features an opening for passengers to access an inside of the cabin 121. Other cabin configurations are contemplated by this application, such as a cabin that is not fully enclosed.

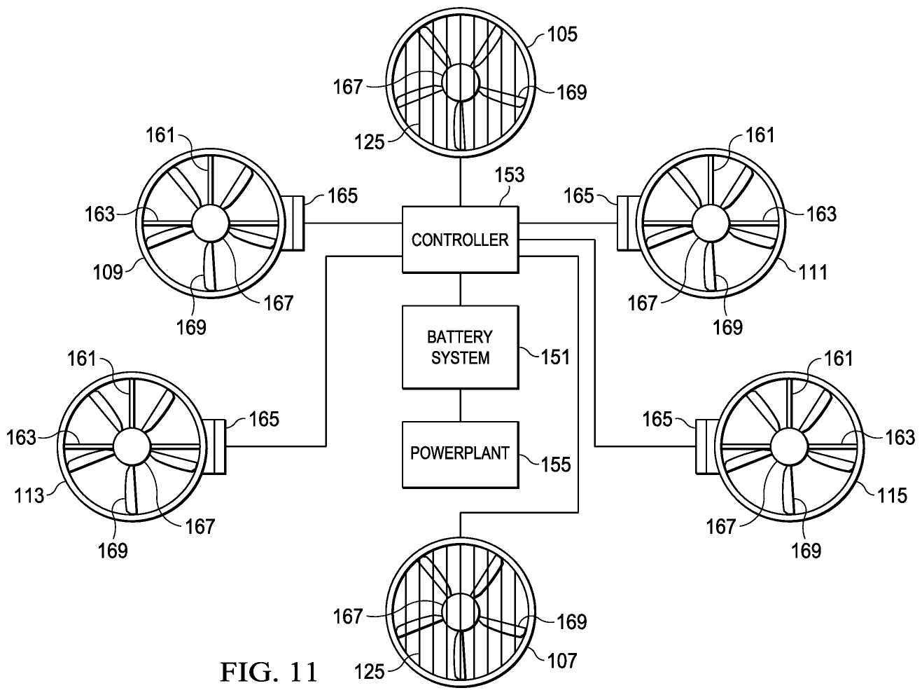

FIG. 11 illustrates various control elements of the rotorcraft 101 according to this disclosure. Rotorcraft 101 is powered by a battery system 151 and controlled by a controller 153. As illustrated, the battery system 151 is powered by powerplant 155. In the preferred embodiment, the powerplant 155 is a gas-fired turbine or combustion engine configured to produce enough electricity to operate all the ducted fans. Since the ducted fans operate from electricity, in some instances the battery system 151 can power the rotorcraft 101 without the need for the powerplant 155. Furthermore, the battery system 151 can be recharged by airborne fuel cells or plugged into a power grid in alternative embodiments.

The forward left ducted fan 109 comprises a vertical control surface 161, a horizontal control surface 163, a tilt actuator 165, an electric motor 167, and an array of fan blades 169. The forward right ducted fan 111 comprises a vertical control surface 161, a horizontal control surface 163, a tilt actuator 165, an electric motor 167, and an array of fan blades 169. The aft left ducted fan 113 comprises a vertical control surface 161, a horizontal control surface 163, a tilt actuator 165, an electric motor 167, and an array of fan blades 169. The aft right ducted fan 115 comprises a vertical control surface 161, a horizontal control surface 163, a tilt actuator 165, an electric motor 167, and an array of fan blades 169. Each horizontal control surface 163 is pivotally attached to the respective ducted fan and selectively rotates relative to the fan to direct thrust. Each vertical control surface 161 is pivotally attached to the respective ducted fan and selectively rotates relative to the fan to direct thrust. The thrust and speed of each ducted fan can be directed by controller 153. Additionally, each outboard ducted fan 109, 111, 113, 115 is pivotally attached to the rotorcraft 101 with the tilt actuator 165 providing selective rotation of the fan. Tilt actuator 165, as controlled by controller 153, enables each outboard ducted fan 109, 111, 113, 115 to pivot from horizontal to a vertical orientation through approximately 90 degrees of rotation, but other amounts of rotation are contemplated by this application.

The forward fuselage ducted fan 105 comprises an electric motor 167, an array of fan blades 169, and the louvers 125. The aft fuselage ducted fan 107 comprises an electric motor 167, an array of fan blades 169, and the louvers 125. Louvers 125 comprise a plurality of slats aligned longitudinally with the rotorcraft 101 with each slat hinged along a side. Louvers 125 are mechanically interconnected and can pivot between an open position and a closed position with an actuator (not shown). During the closed position, the louvers 125 form a circular shape and close an opening of the fan. The position of the louvers 125 is controlled by controller 153. During takeoffs and landings, the louvers 125 remain open, whereas during wing-borne flight the louvers 125 are closed. Both the set of louvers 125 above and below the ducted fans 105, 107 are identical.

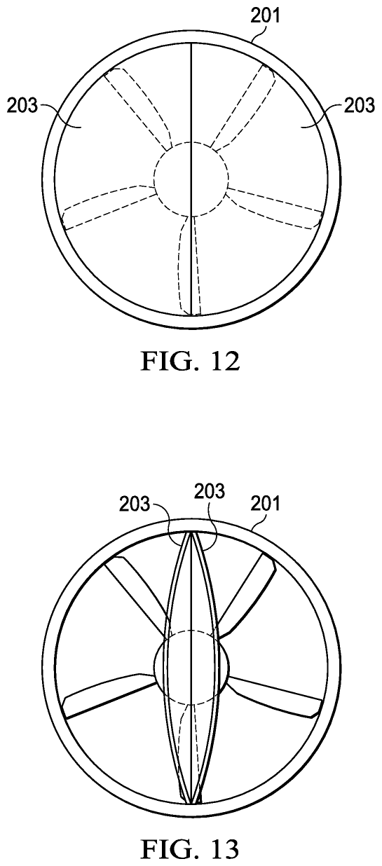

FIGS. 12 & 13 illustrate a fuselage ducted fan 201 equipped with louvered doors 203 according to this disclosure. Fuselage ducted fan 201 features louvered doors 203 above the fan instead of louvers 125. Each of the louvered doors 203 has a half-circle shape and is pivotally attached to the fuselage ducted fan 201 to form a circular cover. Controller 153 moves each of the louvered doors 203 from a closed position illustrated in FIG. 12 to an open position illustrated in FIG. 13 with an actuator (not shown).

At least one embodiment is disclosed, and variations, combinations, and/or modifications of the embodiment(s) and/or features of the embodiment(s) made by a person having ordinary skill in the art are within the scope of this disclosure. Alternative embodiments that result from combining, integrating, and/or omitting features of the embodiment(s) are also within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

What is claimed is:

1. A rotorcraft, comprising:
a fuselage;
a forward ducted fan located in the fuselage;
an aft ducted fan located in the fuselage;
a set of louvers below each fan; and
a set of louvers above each fan;
wherein the louvers are open during use of the fans for providing lift and closed during wing-borne flight.

2. The rotorcraft of claim 1, the rotorcraft further comprises:
a cabin;
a pair of aft wings behind the cabin; and
a pair of aft outboard ducted fans pivotally carried by the aft wings.

3. The rotorcraft of claim 1, the rotorcraft further comprises:
a cabin;
a pair of aft wings behind the cabin;
a pair of aft outboard ducted fans pivotally carried by the aft wings;
a battery system; and
a controller;
wherein each fan comprises;
a set of fan blades; and
an electric motor configured to spin the set of fan blades;
wherein the electric motor is powered by the battery system.

4. The rotorcraft of claim 1, the rotorcraft further comprises:
a cabin;
a pair of aft wings behind the cabin;
a pair of aft outboard ducted fans pivotally carried by the aft wings;
a battery system; and
a controller;
wherein each fan comprises;
a set of fan blades; and
an electric motor configured to spin the set of fan blades;
wherein the electric motor is powered by the battery system; and
wherein each of the outboard ducted fans further comprises;
a vertical control surface pivotally carried by the outboard ducted fan; and
a horizontal control surface pivotally carried by the outboard ducted fan;
wherein the controller controls both the vertical control surface and the horizontal control surface.

5. The rotorcraft of claim 1, further comprising:
a tilt actuator located between each aerodynamic fairing and each outboard ducted fan;
wherein the controller can selectively rotate each outboard ducted fan by rotating the tilt actuator.

6. The rotorcraft of claim 1, wherein the set of louvers above each fan comprises:
a pair of doors each having a half circle shape;
wherein the pair of doors forms a circular cover for the fan when closed.

7. The rotorcraft of claim 1, wherein the set of louvers above each fan comprises:
a plurality of slats, each slat configured to pivot about a longitudinal axis;
wherein the plurality of slats forms a circular cover for the fan when closed.

8. The rotorcraft of claim 1, further comprising:
a cabin; and
an airstair;
wherein the airstair is configured to provide access to the cabin.

9. A rotorcraft, comprising:
a controller;
a battery system;
a powerplant configured to power the battery system;
a fuselage having;
cabin;
a forward fuselage ducted fan;
an aft fuselage ducted fan;
a set of louvers below each fuselage fan; and
a set of louvers above each fuselage fan;
an aft wing located aft of the cabin; and
an outboard ducted fan pivotally coupled to a tilt actuator in the aft wing.

10. The rotorcraft of claim 9, wherein the set of louvers above each fuselage fan comprises:
a pair of doors each having a half circle shape;
wherein the pair of doors pivot along a centerline of each fuselage fan; and
wherein the pair of doors forms a circular cover for the fan when closed.

11. The rotorcraft of claim 9, wherein the set of louvers above each fuselage fan comprises:
a plurality of slats aligned to pivot longitudinally together;
wherein the plurality of slats forms a circular cover for the fan when closed.

12. The rotorcraft of claim 9, further comprising:
a forward aerodynamic fairing located forward of the cabin; and
an outboard ducted fan pivotally coupled to a tilt actuator in the forward aerodynamic fairing.

13. The rotorcraft of claim 9, wherein each of the outboard ducted fans comprises:
a set of fan blades;
an electric motor configured to spin the set of fan blades;
a vertical control surface pivotally carried by the outboard ducted fan; and
a horizontal control surface pivotally carried by the outboard ducted fan;
wherein the electric motor is powered by the battery system; and
wherein the controller controls both the vertical control surface and the horizontal control surface.

14. The rotorcraft of claim 9, further comprising:
an airstair pivotally carried by the fuselage;
wherein the airstair is configured to provide access to the cabin.

15. The rotorcraft of claim 12, wherein the forward aerodynamic fairing is shorter in length as compared to the aft wing.

16. The rotorcraft of claim 9, wherein the aft wing is forward swept.

17. The rotorcraft of claim 9, wherein the powerplant is a combustion engine.

18. The rotorcraft of claim 9, wherein the powerplant is a fuel cell.

19. A method of controlling a rotorcraft, comprising:
providing fuselage ducted fans in a fuselage of the rotorcraft;
providing louvers carried above and below each fuselage ducted fan;
closing the louvers during wing-borne flight; and
opening the louvers for landings.

20. The method of claim 19, further comprising:
providing outboard ducted fans pivotally coupled to the fuselage; and
pivoting the outboard ducted fans from a horizontal position to a vertical position before closing the louvers.
